(19) United States
(12) Patent Application Publication
(10) Pub. No.: US 2006/0134591 A1
(43) Pub. Date: Jun. 22, 2006

(54) Secure media device

(76) Inventor: Lawrence Karat, London (GB)

Correspondence Address: KATTEN MUCHIN ROSENMAN LLP, 525 WEST MONROE STREET, CHICAGO, IL, 60661-3693, US

(21) Appl. No.: 11/233,368

(22) Filed: Sep. 23, 2005

(30) Foreign Application Priority Data
Dec. 17, 2004 (GB) 0427710.9

(51) Int. Cl. G09B 5/00

(52) U.S. Cl. 434/308; 434/317

(57) ABSTRACT

There is disclosed a secure media device. The secure media device comprises a display, a memory and a processor. The display is used for displaying a presentation. The memory is used to store a representation of the presentation, example in digital form. Upon initiation by, for example, a pushbutton, the processor causes the presentation to be displayed on the display. The secure media device may also comprise a loudspeaker. By “secure”, it is meant that the contents of the memory may not readily be read by unauthorised personnel. The memory may be integrated with the processor as a singly integrated circuit or may be mounted to a printed circuit board. Alternatively, the media device may include an enclosure for preventing unauthorised personnel gaining access to the memory.

### FIELD OF THE INVENTION

The present invention relates to a portable media device and, in particular but not exclusively, to a media device for allowing playback of pre-recorded sound and video.

### BRIEF DESCRIPTION OF THE RELATED ART

US2004/0015776 discloses a process for creating an audio visual greeting card. A disadvantage of US2004/0015776 is that the greeting card is recorded onto a video storage medium such as videotape. The videotape is packaged using shrink wrap film and then sent to a recipient. Thus the recipient cannot view the greeting card without first removing the shrink wrap film and inserting the videotape into a videotape player.

According to one aspect of the present invention, there is disclosed a secure media device as set out at claim 1. By “secure”, it is meant that unauthorised personnel cannot readily gain access to the data stored in the memory means such that the data may be copied or changed.

An advantage of such a media device is that unauthorised personnel cannot readily gain access to the data stored in the memory means, and thus unauthorised personnel cannot readily duplicate the presentation stored in the memory means of the media device. This allows the media device to be used as an indication of the authenticity of goods, for example high-value added goods such as perfumes or training shoes.

In some embodiments of the media device, the memory means and the processing means are fabricated as a single silicon integrated circuit (IC). In presently preferred embodiments, the memory means and the processing means are separate silicon ICs that are mounted to a printed circuit board (PCB) and connected together via the PCB. In other embodiments, the memory means may be connected to the processing means via an electrical connector.

Another advantage of such a media device is that the media device is capable of playing back pre-recorded sound and video, thus avoiding the need for a separate player. This allows the media device to be used, for example, to provide users of luxury cars with an introductory reference manual.

Another advantage of such a media device is that the simplicity of the media device allows it to be manufactured at relatively low cost. This allows the media device to be used for applications for which the cost of such a media device has hitherto been regarded as prohibitive. For example, the media device given away for free as a form of product literature, for example in the form of instructions. As one example, the media device may be distributed with do-it-yourself (DIY) laminate flooring and may provide instructions to users for fitting the laminate flooring. As another example, the media device may be distributed as advertising. Recipients of the media device will typically watch the pre-recorded sound and video and then pass the media device on to their friends or colleagues. Thus the media device will be rapidly distributed between people in similar social categories, allowing targeted marketing.

Preferably, the display will be selected from a thin film transistor (TFT) type, a super twisted nematic (STN) type, a colour super twisted nematic (CSTN), an organic light emitting diode (OLED), a polymer light emitting diode (PLED) or an active matrix organic light emitting diode (AMOLED).

The memory will preferably be capable of holding a presentation of at least 5 MBytes, more preferably at least 8 MBytes, even more preferably at least 16 MBytes.

The processor and the display are preferably configured so that the frame rate of the presentation is at least 5 frames per second, more preferably at least 10 frames per second, even more preferably at least 15 frames per second. In a preferred embodiment, the frame rate is about 30 frames per second.

In a preferred embodiment, the device is completely secure, this may be achieved by either manufacturing the device so that the device comprises a read-only memory or no contacts are provided to the memory or the device is physically sealed to present writing to the memory. Preferably the memory is fully encased so that it cannot be rewritten after the device is assembled.

Preferably, the initiator comprises a pushbutton an electrical contact and an insulating strip. The initiator may also comprise a photocell.

In a preferred embodiment, the display has a resolution of 960×234 pixels.

Preferably, the power supply unit comprises a primary battery.

In an embodiment, the device comprises an input wherein the memory is writeable, and the processor is operable to read data from the input and store the data as a presentation in the memory means.

More preferably, the input comprises an image sensor and/or a microphone.

### DESCRIPTION OF DRAWINGS

FIG. 1 shows an isometric view of a first embodiment of the media device, in an unfolded configuration.

FIG. 2 shows a side view of the media device of FIG. 1, in a folded configuration.

FIG. 3 shows a block diagram of the major functional components of electronic circuitry that is incorporated within the media device of FIG. 1.

FIG. 4 shows a plan view of a printed circuit board on which the major components of FIG. 3 are shown.

FIG. 5 shows a second embodiment of the media device.

FIG. 6 shows a greetings card which incorporates the media device of FIG. 5.

FIG. 7 shows packaging for goods incorporating a third embodiment of a media device;

FIG. 8 shows a media device in accordance with a fourth embodiment of the present invention;

FIG. 9 shows the device of FIG. 8 in a closed or folded configuration;

FIG. 10 shows a block diagram of a device in accordance with a fifth embodiment of the present invention.

### DESCRIPTION OF PREFERRED EMBODIMENTS

### First Embodiment

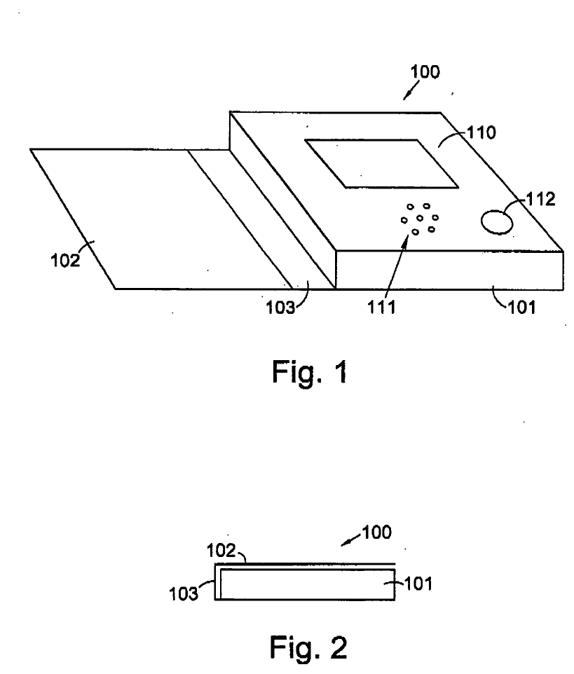

FIG. 1 shows a media device 100 in an unfolded configuration. FIG. 2 shows the media device 100 in a folded configuration. In the folded configuration, this embodiment of the media device has a thickness of 1 cm (centimetre) and a width and height of 9 cm.

The media device 100 comprises a display portion 101 and a cover portion 102 which is connected to the display portion 101 by a spine 103. The display portion 101 comprises a liquid crystal display (LCD) display 110 for displaying animated and static images, a speaker grille 111 for allowing sounds from a loudspeaker (not shown) to reach the user, and a pushbutton 112 which allows the user to initiate a media presentation.

When the user presses the pushbutton 112, a predetermined media presentation is played to the user both visually (via the LCD display 110) and acoustically (via the speaker grille 111). Typically, the media presentation has a duration of 45 s (seconds). Once the media presentation has completed, the media device 100 enters a low-power standby state in which the power consumption of the media device 100 is minimised. If the pushbutton 112 is pressed again, the media device 100 plays the media presentation again. However, eventually batteries (not shown) within the media device 100 will become exhausted and the media device 100 will no longer operate. The media device 100 may then be recycled or discarcded.

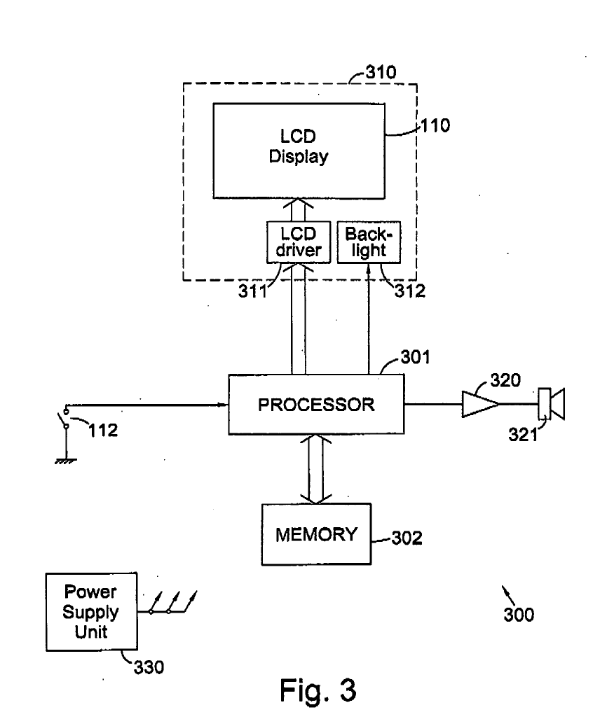

FIG. 3 shows a block diagram of electronic circuitry 300 within the display portion 101. The electronic circuitry 300 comprises the pushbutton 112, a processor 301 and a memory 302. When a user pushes the pushbutton 112, the pushbutton 112 provides the processor 301 with an electrical signal that indicates that the processor 301 should initiate a media presentation.

The processor 301 then reads the memory 302 and decodes a presentation stored in a digital format in the memory 302. For example, a presentation may be stored in the memory 302 using the well known MPEG-4 or Audio Video Interleave (AVI) file formats defined by the Moving Picture Experts Group and Microsoft (RTM), respectively. In this embodiment the memory 302 is a ROM (read only memory) and has a capacity of 256 kB (Kilo bytes). As those skilled in the art will appreciate, the ROM may be mask-programmed or may be electrically programmed. Mask-programmed ROMs are programmed during manufacture of the ROM. Electrically programmed ROMs generally allow data to be written into the ROM once; thereafter the ROM only allows the data to be read from the ROM.

Processors for decoding formats such as MPEG-4 and AVI formats are well known, and thus will not be discussed further. The processor 301 sends image data to an LCD module 310 and sends sound data to an amplifier 320. An example of a processor suitable for decoding MPEG-4 is the TC35274XB processor manufactured by Toshiba Corp. of Japan.

In this embodiment, the processor 301 sends image data to the LCD module 310 in the form of timing signals and red, green, blue (RGB) signals. The RGB signals specify the colour required of pixels of the LCD module 310. In this embodiment, the processor 301 sends sound data in the form of an analogue voltage to the amplifier 320.

The LCD module 310 comprises the LCD display 110 that is visible to the user. The LCD module also comprises an LCD driver 311 and backlight circuitry 312 (neither of which is visible to the user during ordinary use of the media device 100). The LCD driver 311 receives the timing and RGB signals from the processor 301 and converts these into signals suitable for driving row and column electrodes (not shown) of the LCD display 110. The backlight circuitry 312 generates a voltage suitable for a cold cathode lamp (CCL) lamp (not shown). The CCL lamp illuminates the reverse of the LCD display 110 and thus light from the CCL lamp is modulated by the LCD display 110 to form an image visible to a user of the media device 100. An example of an LCD module that is suitable for use in the PW036XS3 LCD module manufactured by Prime View International Co Ltd of Taiwan. The PW036XS3 LCD module has a resolution of 960×234 pixels.

The amplifier 320 amplifies the analogue voltage from the processor 301 to provide a signal of sufficient strength to drive a loudspeaker 321. The loudspeaker 321 is positioned in the display portion 101 underneath the speaker grille 111.

A power supply unit (PSU) 330 provides electrical power for the processor 301, LCD module 310 etc. In this embodiment the PSU 330 comprises three miniature batteries such as are commonly used in devices such as hearing aids.

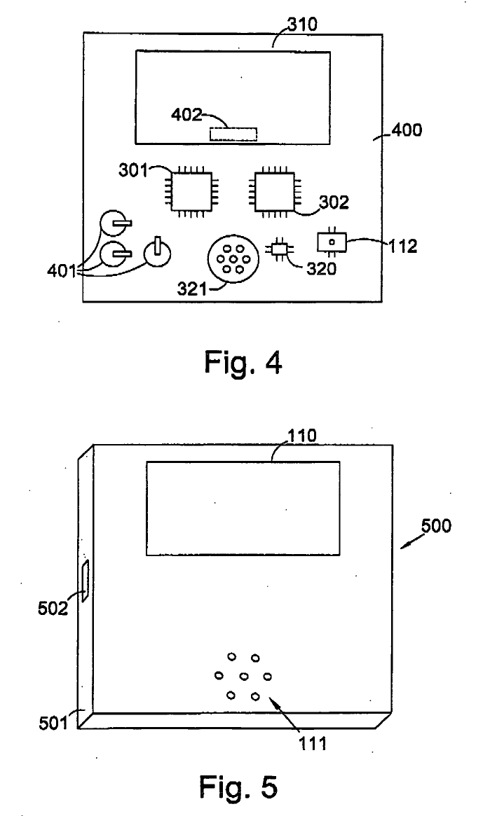

FIG. 4 shows a printed circuit board (PCB) 400 on which the electrical circuitry 300 is assembled. The PCB 400 has dimensions in this embodiment of 8 cm by 8 cm so that it fits inside the display portion 101. As is well known to those skilled in the art, the PCB 400 comprises an electrically insulating substrate provided with a predetermined pattern of copper to electrically connect the electrical components of the electronic circuitry 300.

In this embodiment the processor 301 is a single IC (integrated circuit) that is directly soldered onto the PCB 400. The memory 302 is also a single IC that is directly soldered onto the PCB 400. FIG. 4 also shows that the pushbutton 112, amplifier 320 and loudspeaker 321 are soldered to the PCB 400. The three batteries 401 of the PSU 330 are mounted onto the PCB as shown. As is well known to those skilled in the art, a piece of conductive rubber 402 is used to connect the LCD module 310 to the PCB 400.

The mounting of the memory 302 and processor 301 directly on the PCB 400 provides security as it is relatively difficult for unauthorised personnel to read the data stored in the memory 302. For example, it is difficult for unauthorised personnel to read out the data stored in the memory 302 as the soldering of the memory 302 to the PCB 400 precludes the attachment of test electrodes of equipment such as logic analysers (as is known to those skilled in the art, logic analysers are items of electronic test equipment that may be used to monitor the electrical signals of a memory and thus record the data stored in a memory).

### Second Embodiment

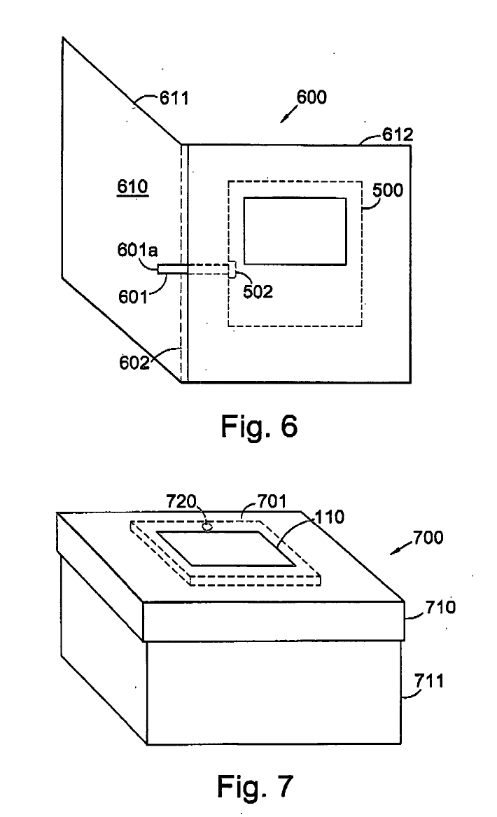

FIG. 5 shows a module 500 that may be inserted into a product such as a greetings card 600 as shown by FIG. 6.

The module 500 is based on the PCB 400 illustrated in FIG. 4 but, rather than relying on a display portion 101 for packaging, the module 500 is packaged within an enclosure 501. The enclosure 501 protects the PCB (not visible) from rough handling and allows the module 500 to be supplied to greetings card manufacturers for incorporation into greetings cards 600. In this embodiment the enclosure 501 is formed from injection moulded plastic.

The module 500 has a speaker grille 111 but does not have a pushbutton 112. Instead, a slot 502 is provided in a side of the module. A piece of insulator (not shown) may be inserted into the slot and retracted to trigger the processor (not shown) to begin playback of the media presentation.

FIG. 6 shows in more detail how an insulator strip 601 is used to trigger playback. The front 611 and back 612 of the greetings card 600 are connected at a fold 602. One end 601a of the insulator strip 601 is connected to the inside surface 610 of the front 611 of the greetings card 600 at a position a small distance (in this embodiment 5 mm) from the fold 602. The other end of the insulator strip 601 is retained within the slot 502. When the greetings card 600 is opened, the insulator strip 601 is partially withdrawn from the slot 502, thus allowing an electrical contact (not shown) within the module 500 to close, thus initiating playback.

The back 612 of the greetings card 600 defines a pocket within which the module 500 is secured. In this embodiment sounds from the loudspeaker pass through the greetings card 600 though in alternative embodiments a speaker grille could be punched into the greetings card 600.

### Third Embodiment

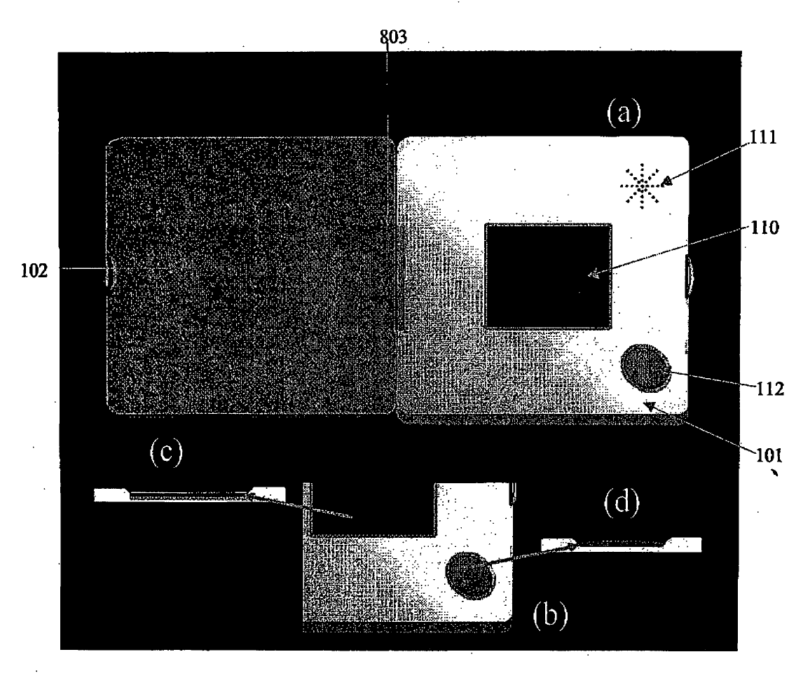

In this embodiment the media device is embedded in packaging for goods, for example a shoe box for training shoes or packaging for a perfume. FIG. 7 shows a shoe box 700 comprising a box lid 710 and a box 711. A module 701 similar to the module 500 is attached to the box lid 710.

In this embodiment, the media presentation is triggered when the box lid 710 is removed from the box 711. A photocell 720 is provided in the module 701. When the box lid 710 is mounted to the box 711 then ambient light is prevented from reaching the photocell 720. When the box lid 710 is removed from the box 711 then ambient light is allowed to reach the photocell, thus triggering playback of the media presentation.

### Fourth Embodiment

The fourth embodiment is based on the first embodiment and illustrates the media device in a slim-line hinged configuration.

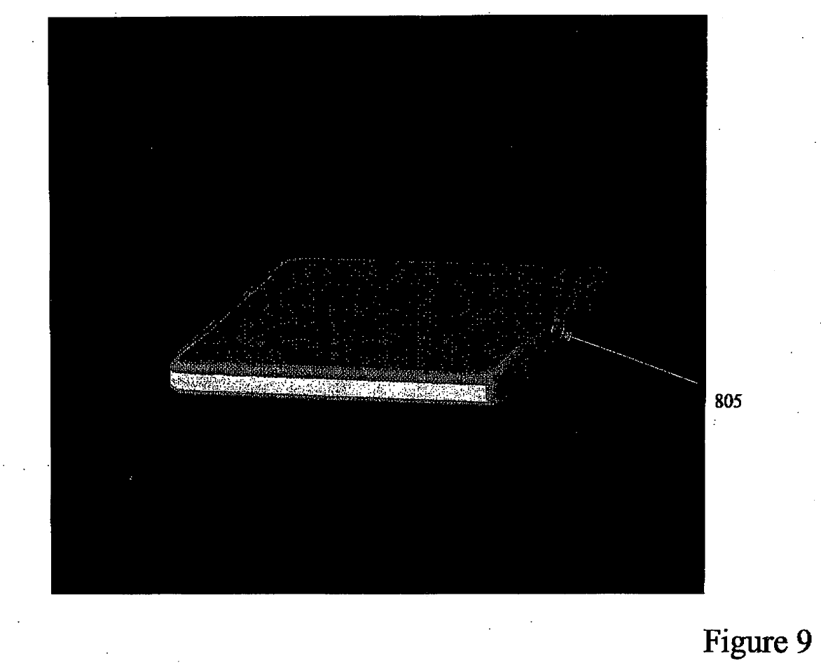

FIG. 8 (a) shows the whole device in an open or unfolded position. FIG. 8(b) is a partial view of the corner of device of FIG. 8(a). FIG. 8(c) is a cross section of the display portion and FIG. 8(d) is a cross section of the pushbutton. FIG. 9 shows the device in a closed position.

To avoid unnecessary repetition like reference numerals will be used to denote like features. The device 100 comprises a display portion 101, and a cover portion 102 connected to the display portion by a hinge 803. The overall thickness of the device 100 i.e. the thickness of the display portion 101 and the cover portion 102 is approximately 1 cm.

The display portion comprises an LCD display 110 which may be of the TFT of CSTN type. The display 110 is sunk into the display portion 101 as shown in the cross section of FIG. 8(c).

The display 110 is provided roughly in the centre of the display portion 101, with a speaker grille 111, in the shape of a star provided in the top right hand corner. The speaker grille 111 may be placed at any position on the display portion 101.

The pushbutton 112 is located in lower right hand corner of the display portion 101 and is sunk below the level of the display portion as shown in FIG. 8(d).

The pushbutton 112 activates the media device 101 in the same manner as described for the first embodiment.

FIG. 9 shows a device in accordance with the fourth embodiment in a folded or closed position. Catch 805 is provided to fix the cover 102 in the closed position. In the closed configuration the dimensions of the device are approximately 1 cm×10 cm×10 cm.

### Fifth Embodiment

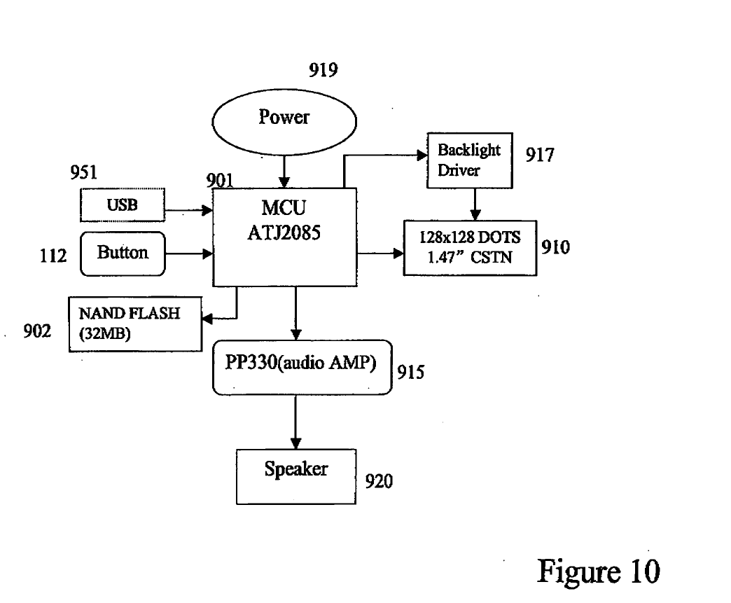

FIG. 10 shows a block circuit diagram of a device in accordance with a fifth embodiment of the present invention. A processor 901 is connected to a memory 902, a USB port 951 and pushbutton 112. Unlike embodiment 1, the memory 902 is a reprogrammable NAND Flash type memory and a USB port 951 is provided to allow rewriting of the memory 902. When the processor 901 receives an input from pushbutton 112, the processor initiates a media presentation stored on memory 902.

The processor 901 then sends image data to display 910 and sound data to amplifier 915 which then produces sound at speaker 920. The amplifier may be a PP330 audio amp. The display 910 in this embodiment is a Colour Super Twist Nematic (CSTN) type which may be driven by a processor such as the ATJ2085 processor from Action Semiconductors. The display 910 is backlit using backlight driver 917.

The power to the system is delivered via power source 919 which is preferably a flat battery capable of powering the system to play the contents of the memory between 50 and 100 times before the battery needs to be changed.

In the fifth embodiment, the system may be made secure by physically sealing the USB port 951 after the declined information has been programmed into the memory 902. Alternatively the memory may be write protected using conventional read or write protect software.

### Other Embodiments

Instead of a resolution of 960×324 pixels as is provided by the PW036XS3 LCD module mentioned above, other embodiments may have a higher or a lower resolution.

Also, instead of using a colour LCD module, black-and-white or grey scale modules may be used instead. Although the use of LCD modules is currently preferred, other types of display modules that may be used include those based on light emitting diodes (LEDs) or plasma displays. When LCD displays are used, the LCD display may be of the thin film transistor (TFT) type, super twisted nematic (STN) type or a colour super twisted nematic (CSTN). When LED displays are used, the LED display may be of the organic light emitting diode (OLED) type, active matrix organic light emitting diode (AMOLED) type or polymer light emitting diode type (PLED).

The use of sound is preferred to provide an audio-visual playback. However, the loudspeaker and amplifier may be omitted from some embodiments.

A vibrating device may be included in some embodiments in order to provided an enhanced sensation during the playback of, for example, multimedia presentations that include actions sequences (for example during film trailers that incorporate explosions). The vibrating device may be provided as a miniature electric motor with a weight mounted eccentrically to the shaft of the motor.

The embodiments described above had a processor 301 and a separate memory 302. In alternative embodiments, the processor and memory may be integrated into a single IC. An advantage of using a single IC is that it is difficult for unauthorised personnel to read the data that represents the media presentation. This is because during playback of the media presentation, all of the signals between the memory and the processor are between different regions of a single IC, thus making it even more difficult for unauthorised personnel to monitor the data (and thus making it difficult for unauthorised personnel to record and then re-distribute the data). A single IC is preferred in situations where the economies of scale make this more cost effective than using a separate processor and memory.

In other embodiments, rather than using a memory IC 302 mounted to a PCB 400, a plug-in memory such as a FLASH non-volatile memory card or a universal serial bus (USB) memory device may be connected to an electrical connector provided on the PCB. (Note that unlike the ROM mentioned above, data may be read from and written to FLASH memory.) The need for an electrical connector may increase the cost but in some situations the use of a connector may be preferred as this would allow the use of a simplified manufacturing process compared to the mounting of a memory IC directly on a PCB. In yet other embodiments, a miniature CD-ROM drive or a miniature hard disk may be used to strore information defining a media presentation. Where, for example, a FLASH memory card or a miniature CD-ROM drive or a hard disk is used, the packaging of the media device is arranged so that this is not readily apparent to a user of the media device (thus there are no external apertures allowing the FLASH memory card to be unplugged from an electrical connector and removed from the media device through the aperture, nor an aperture allowing a miniature CD-ROM to be removed from the media device). Thus another advantage of the enclosure 501 is that access to the component parts of the media device is restricted.

Although the use of compressed formats such as MPEG-4 and AVI is preferred (in order to minimise the required capacity of the memory 302), in other embodiments the media presentation may be stored in an uncompressed format.

The greetings card 600 allowed the playback of pre-recorded media presentations. In an alternative embodiment, a modified module (not shown) may be used as, for example, a customisable postcard. In such an embodiment, the module is provided with an input device, for example one of a camera and a microphone. A user records video and/or sounds using the camera/microphone and can then send the postcard to a friend. On receipt of the postcard, the friend presses the pushbutton 112 (or some other initiator) to begin playback of video and sounds previously recorded into the memory of the postcard.

In some embodiments the PSU may comprise, for example, one or more re-chargeable cells and a switched mode power supply (SMPS) to convert the voltage from the cell(s) to a voltage suitable for use by the processor 301 etc. If the PSU comprises re-chargeable cells then the media device may be provided with an electrical connector provided at the exterior of the media device to allow re-charging of the re-chargeable cells. Alternatively, the media device may be provided with inductive coupling means to allow electrical energy to be coupled into the re-chargeable cells without the use of an electrical connector.

In some embodiments, the media device may be provided with a timer. The timer allows the media device to be used for a period and then the functionality of the media device is inhibited (even if the PSU has sufficient energy to allow further playback of the presentation). The use of a timer allows the media device to be used, for example, for up to one month.

In some embodiments, the media device may be provided with a counter. Each time the presentation is played back, a count value of the counter is incremented. If the count value of the counter reaches a threshold then the functionality of the media device is inhibited (even if the PSU has sufficient energy to allow further playback of the presentation). The use of a counter allows the media device to be used, for example, for up to one hundred playbacks of the presentation.

Although embodiments described earlier used a single PCB, in other embodiments two PCBs may be used, with one PCB in each side of the media device or greetings card.

Embodiments described above had, for example, a single pushbutton 112 to initiate playback of the presentation. In alternative embodiments, the pushbutton 112 (or a plurality of pushbuttons) may be used to allow the media device to provide an interactive presentation. For example, in embodiments where the media device is used to provide instructions, the presentation may be arranged to require an indication from the user that he has understood a previous portion of the presentation before playing a succeeding portion of the presentation. The user provides the indication using the pushbutton(s). In such embodiments of the media device, the processor is arranged to detect the electrical state of the pushbutton(s) and playback the appropriate portion(s) of the presentations.

Process for Making a Media Device

An example of a process for a making a media device according to the present invention is as follows.

First, a design concept for a presentation is agreed with a client.

Second, the design concept is developed. This may include producing hard copies of visuals, for example in the form of a story board. This may also include creating animations (for example using software packages such as Flash or Shockwave available from Macromedia).

Third, the design concept is shown to the client for approval by the client. The design concept may be shown directly to the client or may be emailed to the client.

Fourth, final artwork for the presentation is prepared. This may include artwork and/or shooting editing of film and/or video. Typically, this step will also include converting the artwork to a format such as MPEG-4.

Fifth, a sample of the finished artwork (i.e. the MPEG-4 presentation as well as the appearance of the media device) is prepared for the client to sign off.

Sixth, the media device is manufactured using to the appearance approved by the client. The presentation is also written into memory devices for incorporation into media devices.

Seventh, the media device is sealed after the presentation has been written to the memory.

Applications of the Media Device

Example of the application of the media device were mentioned above in which the media device is used: as an introductory reference manual, to provide advertising, as a greetings card, as packaging to authenticate goods and as a postcard. The media device may also be used to promote, for example, films and/or music. Further applications of the media device are for the promotion of baseball caps, t-shirts, jackets and bags.

1. A secure media device comprising:
a display;
a memory for storing data representing a presentation;
a processor for reading the data from the memory and causing the presentation to be displayed on the display device;
an initiator for initiating playback; and
a power supply unit.

2. A secure media device according to claim 1, comprising a loudspeaker, wherein the processor means is operable to cause data representing the presentation to be outputted through the loudspeaker.

3. A secure media device according to claim 1; wherein the display comprises one or more of: an LCD display, an LED display, a plasma display.

4. A secure media device according to claim 3, wherein the display is of the thin film transistor (TFT) type, super twisted nematic type (STN), colour super twisted nematic type (CSTN), organic light emitting diode (OLED) type, polymer light emitting diode (PLED) type. Active matrix organic light emitting diode (AMOLED).

5. A secure media device according to claim 1, wherein the display is operable to display colour images.

6. A secure media device according to claim 1, wherein the memory has a size of at least 5 MBytes.

7. A secure media device according to claim 1 wherein the processor and display are configured to display at a frame rate of at least 5 frames per second.

8. A secure media device according to claim 1, comprising a vibrating device.

9. A secure media device according to claim 1, comprising a counter means for inhibiting playback of the presentation once the number of playbacks has exceeded a threshold.

10. A secure media device according to claim 1, comprising a timer means for inhibiting playback of the presentation once a time limit has passed.

11. A secure media device according to claim 1, comprising indication means for receiving an indication from a user, wherein the processor means is operable to display the presentation on the display device in dependence on the indication means.

12. A secure media device according to claim 11, wherein the indication means comprises one or more pushbuttons, and wherein the processor means is operable to pause playback of the presentation until an indication is received from one of the push buttons.

13. A secure media device according to claim 1, wherein the memory means and processor means are embodied as a single integrated circuit.

14. Packaging for a product, wherein the packaging comprises a secure media device according to claim 1.

15. A method of producing a secure media device according to claim 1, comprising the steps of:
producing data representing a presentation;
writing the data into a memory means; and
assembling and sealing the secure media device.

16. A method of promoting a service or product, comprising the step of distributing a secure media device according to claim 1.
